(19) United States
(12) Patent Application Publication
(10) Pub. No.: US 2017/0068901 A1
(43) Pub. Date: Mar. 9, 2017

(54) RECOMMENDATION METHOD AND APPARATUS

(71) Applicant: Beijing Zhigu Rui Tuo Tech Co., Ltd., Beijing (CN)

(72) Inventor: Kuifei Yu, Beijing (CN)

(21) Appl. No.: 15/239,457

(22) Filed: Aug. 17, 2016

(30) Foreign Application Priority Data
Sep. 7, 2015 (CN) 201510562895.2

(51) Int. Cl. G06N 7/00; G06N 5/02

(52) U.S. Cl. CPC G06N 7/005; G06N 5/022

(57) ABSTRACT

Embodiments of this application disclose a recommendation method, comprising: determining, according to a hidden variable characteristic parameter of a user and a hidden variable characteristic parameter of each branch node of a content tree, a probability that the user selects each branch node on an nth level of the content tree; and recommending, to the user according to the probability that the user selects each branch node on the nth level of the content tree, a content category corresponding to at least one branch node on the nth level of the content tree. This application further discloses another recommendation method and recommendation apparatus. According to the recommendation method and apparatus in the embodiments of this application, a probability that a user selects each node on a specific level in a tree structure of to-be-recommended contents can be determined according to a hidden variable characteristic parameter of the user, and a recommendation is given based on the probability, which overcomes a problem in the prior art that a need of a user for customization is overlooked, so that a customized recommendation can be given to a user more accurately.

### TECHNICAL FIELD

This application relates to the field of computer technologies, and in particular, to a recommendation method and apparatus.

### BACKGROUND

In recent years, with the rapid popularization and development of mobile Internet and intelligent mobile devices, many intelligent mobile applications (App) emerged. These various types of mobile Apps meet function needs of mobile users in various aspects of daily life such as food, clothing, housing, and transportation, but a user may find it difficult to choose among the large number of mobile Apps.

Currently, there are mainly two mobile App recommendation methods. One is a recommendation method based on popularity, for example, recommending a mobile App to a user according to a quantity of download times and a score of the mobile App. The other is recommendation based on functions, for example, recommending the most secure App to a user. However, in both of the methods, because same content is displayed to all users, a need of a user for customization is overlooked.

### SUMMARY

An objective of this application is to provide a recommendation method and apparatus.

According to a first aspect of at least one embodiment of this application, a recommendation method is provided, comprising:

determining, according to a hidden variable characteristic parameter of a user and a hidden variable characteristic parameter of each branch node of a content tree, a probability that the user selects each branch node on an nth level of the content tree, where one branch node of the content tree corresponds to one content category, and n is a natural number greater than 1; and

recommending, to the user according to the probability that the user selects each branch node on the nth level of the content tree, a content category corresponding to at least one branch node on the nth level of the content tree.

According to a second aspect of at least one embodiment of this application, another recommendation method is provided, comprising:

determining, according to a hidden variable characteristic parameter of a user and a hidden variable characteristic parameter of each leaf node of a content tree, a probability that the user selects each leaf node of the content tree, where one leaf node of the content tree corresponds to one content; and

recommending, to the user according to the probability that the user selects each leaf node of the content tree, a content corresponding to at least one leaf node of the content tree.

According to a third aspect of at least one embodiment of this application, a recommendation apparatus is provided, comprising:

a probability determining module, configured to determine, according to a hidden variable characteristic parameter of a user and a hidden variable characteristic parameter of each branch node of a content tree, a probability that the user selects each branch node on an nth level of the content tree, where one branch node of the content tree corresponds to one content category, and n is a natural number greater than 1; and

a recommendation module, configured to recommend, to the user according to the probability that the user selects each branch node on the nth level of the content tree, a content category corresponding to at least one branch node on the nth level of the content tree.

According to a fourth aspect of at least one embodiment of this application, another recommendation apparatus is provided, comprising:

a probability determining module, configured to determine, according to a hidden variable characteristic parameter of a user and a hidden variable characteristic parameter of each leaf node of a content tree, a probability that the user selects each leaf node of the content tree, where one leaf node of the content tree corresponds to one content; and

a recommendation module, configured to recommend, to the user according to the probability that the user selects each leaf node of the content tree, a content corresponding to at least one leaf node of the content tree.

According to a fifth aspect of at least one embodiment of this application, another recommendation apparatus is provided, comprising: a memory and a processor, where the memory is configured to store an instruction; and the processor is configured to execute the instruction, to perform the following steps:

determining, according to a hidden variable characteristic parameter of a user and a hidden variable characteristic parameter of each branch node of a content tree, a probability that the user selects each branch node on an nth level of the content tree, where one branch node of the content tree corresponds to one content category, and n is a natural number greater than 1; and

recommending, to the user according to the probability that the user selects each branch node on the nth level of the content tree, a content category corresponding to at least one branch node on the nth level of the content tree.

According to a sixth aspect of at least one embodiment of this application, another recommendation apparatus is provided, comprising: a memory and a processor, where the memory is configured to store an instruction; and the processor is configured to execute the instruction, to perform the following steps:

determining, according to a hidden variable characteristic parameter of a user and a hidden variable characteristic parameter of each leaf node of a content tree, a probability that the user selects each leaf node of the content tree, where one leaf node of the content tree corresponds to one content; and

recommending, to the user according to the probability that the user selects each leaf node of the content tree, a content corresponding to at least one leaf node of the content tree.

According to the recommendation method and apparatus in the embodiments of this application, a probability that a user selects each node on a specific level in a tree structure of to-be-recommended contents can be determined according to a hidden variable characteristic parameter of the user, and a recommendation is given based on the probability, which overcomes a problem in the prior art that a need of a user for customization is overlooked, so that a customized recommendation can be given to a user more accurately.

### BRIEF DESCRIPTION OF THE DRAWINGS

FIG. 1 is a schematic flowchart of a recommendation method according to an embodiment of this application;

FIG. 2 shows a tree structure described in an embodiment of this application;

FIG. 3 is a schematic flowchart of another recommendation method according to an embodiment of this application;

FIG. 4 is a schematic flowchart of a recommendation method according to another embodiment of this application;

FIG. 5 is a schematic flowchart of another recommendation method according to another embodiment of this application;

FIG. 6 is a schematic flowchart of another recommendation method according to an embodiment of this application;

FIG. 7 is a schematic flowchart of another recommendation method according to another embodiment of this application;

FIG. 8 is a schematic structural diagram of a recommendation apparatus 800 according to an embodiment of this application;

FIG. 9 is a schematic structural diagram of another recommendation apparatus 800 according to an embodiment of this application;

FIG. 10 is a schematic structural diagram of another recommendation apparatus 800 according to an embodiment of this application;

FIG. 11 is a schematic structural diagram of a recommendation apparatus 1100 according to another embodiment of this application;

FIG. 12 is a schematic structural diagram of another recommendation apparatus 1100 according to another embodiment of this application;

FIG. 13 is a schematic structural diagram of another recommendation apparatus 1100 according to another embodiment of this application;

FIG. 14 is a schematic structural diagram of a recommendation apparatus 1400 according to another embodiment of this application; and

FIG. 15 is a schematic structural diagram of a recommendation apparatus 1500 according to another embodiment of this application.

### DETAILED DESCRIPTION

The following describes specific implementation manner of this application in further detail with reference to accompanying drawings and embodiments. The following embodiments are used to describe this application, and are not used to limit the scope of this application.

A person skilled in the art understands that in the embodiments of this application, sequence numbers of the following steps do not indicate execution order, and the execution order of the steps should be determined by functions and internal logic of the steps, and the sequential numbers do not constitute any limitation on an implementation process of the embodiments of this application.

Besides, terms such as “first” and “second” in this application are merely used to distinguish different steps, devices, modules, or the like, and do not imply any particular technical meaning or necessary logic order between them.

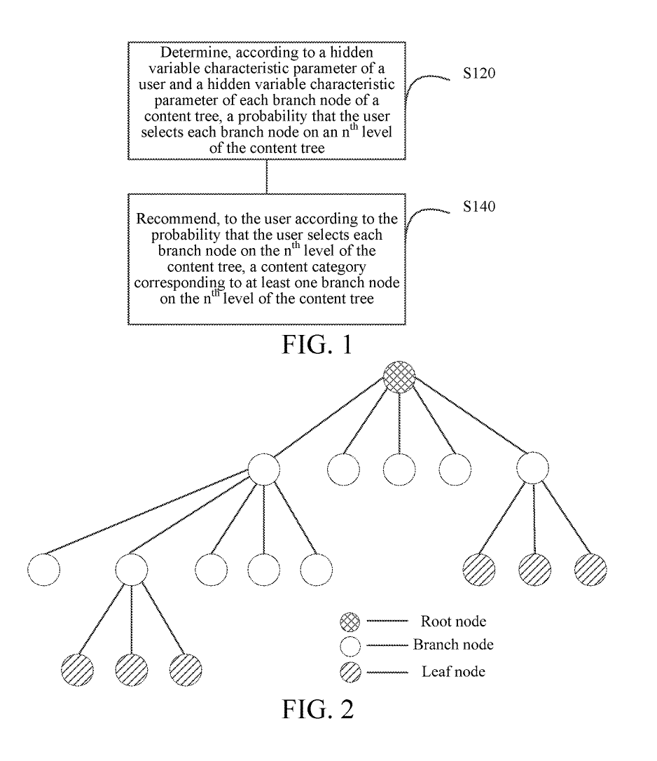

FIG. 1 is a schematic flowchart of a recommendation method according to an embodiment of this application. Referring to FIG. 1, the method comprises:

S120: Determine, according to a hidden variable characteristic parameter of a user and a hidden variable characteristic parameter of each branch node of a content tree, a probability that the user selects each branch node on an nth level of the content tree.

One branch node of the content tree corresponds to one content category, and n is a natural number greater than 1.

S140: Recommend, to the user according to the probability that the user selects each branch node on the nth level of the content tree, a content category corresponding to at least one branch node on the nth level of the content tree.

According to the recommendation method in this embodiment of this application, a probability that a user selects each branch node on a specific level in a tree structure of to-be-recommended contents can be determined according to a hidden variable characteristic parameter of the user, and a recommendation of a content category is given based on the probability, which overcomes a problem in the prior art that a need of a user for customization is overlooked, so that a customized recommendation can be given to a user more accurately.

In this embodiment of this application, as shown in FIG. 2, contents are in a form of a tree structure; starting with a root node, a user faces multiple choices of branch nodes on each level, and some potential preferences of the user may affect a choice made by the user. Therefore, in this embodiment of this application, a hidden variable characteristic parameter of a user may be used to describe potential factors such as various preferences of the user, and a hidden variable characteristic parameter of a branch node of a content tree may be used to describe a preference degree of the user for a content category among the various preferences.

For example, a hidden variable characteristic parameter of a user u may be a k-dimension vector [symbol] , and a hidden variable characteristic parameter of a branch node z of a content tree may be a k-dimension vector [symbol] , where k is any natural number.

Generally, a greater similarity degree between a hidden variable characteristic parameter of a branch node and a hidden variable characteristic parameter of a user indicates greater preference of the user for a content category corresponding to the branch node and a greater probability that the user selects the content category.

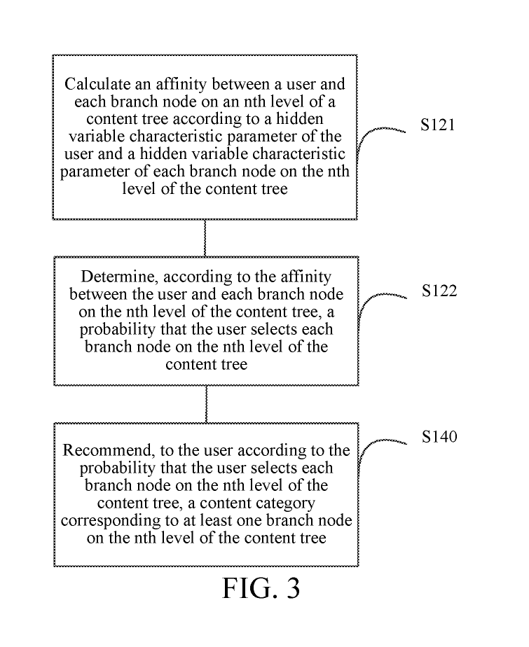

Therefore, optionally, as shown in FIG. 3, the determining, according to a hidden variable characteristic parameter of a user and a hidden variable characteristic parameter of each branch node of a content tree, a probability that the user selects each branch node on an nth level of the content tree (S120) may comprise:

S121: Calculate an affinity between the user and each branch node on the nth level of the content tree according to the hidden variable characteristic parameter of the user and a hidden variable characteristic parameter of each branch node on the nth level of the content tree.

S122: Determine, according to the affinity between the user and each branch node on the nth level of the content tree, the probability that the user selects each branch node on the nth level of the content tree.

For example, an affinity may be used to describe a similarity degree between a hidden variable characteristic parameter of a branch node and a hidden variable characteristic parameter of a user, and a greater affinity indicates a greater similarity degree between the two. For example, if the hidden variable characteristic parameter of the user and the hidden variable characteristic parameter of the branch node are represented by the foregoing k-dimension vectors [symbol] and [symbol] , the affinity between the two may be represented by a dot product of the two vectors:

y_{uz}= [symbol] · [symbol] +b_{z} formula 1,

where

b_{z} is a bias term of the branch node z, and may be preset according to an actual situation, or may be obtained by using a machine learning method such as maximum likelihood estimation.

After the affinity is determined, it can be determined that a probability that the user u selects the branch node z under a content category corresponding to a root node π(z) of the content tree or a content category corresponding to a branch node π(z) of the content tree is:

$${P}_{r} ( z \vert u , π ( z ) ) = \frac{exp ( {y}_{uz} )}{{\sum }_{{z}^{′} ∈ c ( π ( z ) )} exp ( {y}_{{uz}^{′}} )} , \qquad formula 2$$

where

π(z) is a father node of the branch node z, and c(π(z)) is a set of all child nodes of the node π(z), that is, a set comprising the branch node z and all brother nodes of the branch node z.

After a probability that the user u selects each branch node on a specific level is determined, a content category corresponding to at least one branch node on the level may be recommended to the user u based on the probability, for example, a content category corresponding to a branch node whose probability is the highest may be recommended; or content categories corresponding to several branch nodes whose probabilities are highest may be recommended; or content categories corresponding to branch nodes whose probabilities are greater than a set probability threshold may be recommended, which is not specifically limited in this embodiment of this application.

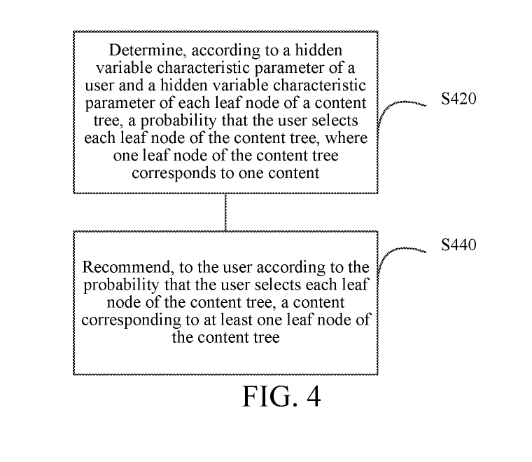

FIG. 4 is a schematic flowchart of another recommendation method according to another embodiment of this application. Referring to FIG. 4, the method comprises:

S420: Determine, according to a hidden variable characteristic parameter of a user and a hidden variable characteristic parameter of each leaf node of a content tree, a probability that the user selects each leaf node of the content tree, where one leaf node of the content tree corresponds to one content.

S440: Recommend, to the user according to the probability that the user selects each leaf node of the content tree, a content corresponding to at least one leaf node of the content tree.

According to the recommendation method in this embodiment of this application, a probability that a user selects each leaf node in a tree structure of to-be-recommended contents can be determined according to a hidden variable characteristic parameter of the user, and a recommendation of a content is given based on the probability, which overcomes a problem in the prior art that a need of a user for customization is overlooked, so that a customized recommendation can be given to a user more accurately.

In this embodiment of this application, contents are in a form of a tree structure; starting with a root node, a user faces multiple choices of branch nodes on each level, and some potential preferences of the user may affect a choice made by the user. Therefore, in this embodiment of this application, a hidden variable characteristic parameter of a user may be used to describe potential factors such as various preferences of the user, and a hidden variable characteristic parameter of a leaf node of a content tree may be used to describe a preference degree of the user for a content among the various preferences.

For example, a hidden variable characteristic parameter of a user u may be a k-dimension vector [symbol] , and a hidden variable characteristic parameter of a leaf node i of a content tree may be a k-dimension vector [symbol] , where k is any natural number.

Generally, a greater similarity degree between a hidden variable characteristic parameter of a leaf node and a hidden variable characteristic parameter of a user indicates greater preference of the user for a content corresponding to the leaf node and a greater probability that the user selects the content.

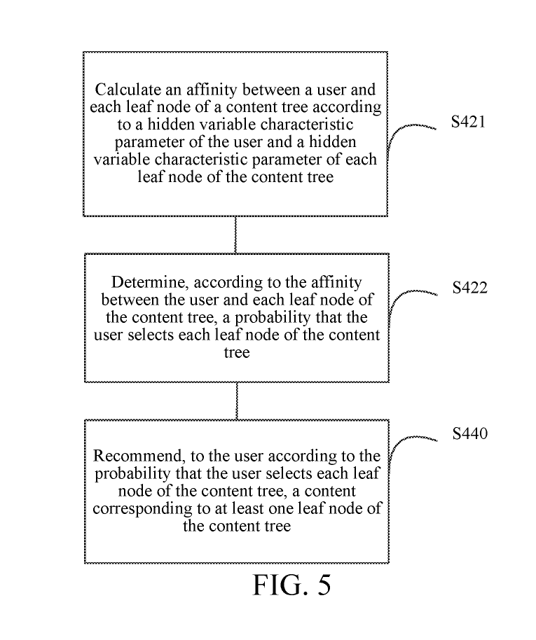

Therefore, optionally, as shown in FIG. 5, the determining, according to a hidden variable characteristic parameter of a user and a hidden variable characteristic parameter of each leaf node of a content tree, a probability that the user selects each leaf node of the content tree (S420) may comprise:

S421: Calculate an affinity between the user and each leaf node of the content tree according to the hidden variable characteristic parameter of the user and the hidden variable characteristic parameter of each leaf node of the content tree.

S422: Determine, according to the affinity between the user and each leaf node of the content tree, the probability that the user selects each leaf node of the content tree.

For example, similar to the foregoing embodiment, an affinity may be used to describe a similarity degree between a hidden variable characteristic parameter of a leaf node and a hidden variable characteristic parameter of a user, and a greater affinity indicates a greater similarity degree between the two. In a specific application, if the hidden variable characteristic parameter of the user and the hidden variable characteristic parameter of the leaf node are represented by the foregoing k-dimension vectors [symbol] and [symbol] , the affinity between the two may be represented by a dot product of the two vectors:

yᵤᵢ= [symbol] · [symbol] +bᵢ formula 3,

where

bᵢ is a bias term of a leaf node i, and may be preset according to an actual situation, or may be obtained by using a machine learning method such as maximum likelihood estimation.

After the affinity is determined, it can be determined that a probability that the user u selects the leaf node i under a content category corresponding to the branch node z of the content tree is:

$${P}_{r} ( i \vert u , z ) = \frac{exp ( {y}_{ui} )}{{\sum }_{j ∈ c ( z )} exp ( {y}_{uj} )} , \qquad formula 4$$

where

the branch node z is a father node of the leaf node i, and c(z) is a set of all child nodes of the branch node z, that is, a set comprising the leaf node i and all brother nodes of the leaf node i.

With reference to formula 1 to formula 4, it can be obtained that the probability that the user u selects the leaf node i on the content tree is:

$$\begin{matrix}{P}_{r} ( i \vert u ) = {P}_{r} ( i \vert u , {z}_{M} ) {\prod }_{m = 1}^{M} {P}_{r} ( {z}_{m} \vert u , {z}_{m - 1} ) \\ = \frac{exp ( \vec{{p}_{u}} \cdot \vec{{q}_{i}} + {b}_{i} )}{{\sum }_{j ∈ c ( {z}_{M} )} exp ( \vec{{p}_{u}} \cdot \vec{{q}_{j}} + {b}_{j} )} {\prod }_{m = 1}^{M} \\ \frac{exp ( \vec{{p}_{u}} \cdot \vec{{q}_{{z}_{m}}} + {b}_{{z}_{m}} )}{{\sum }_{{z}^{′} ∈ c ( {z}_{m - 1} )} exp ( \vec{{p}_{u}} \cdot \vec{{q}_{{z}^{′}}} + {b}_{{z}^{′}} )} ,\end{matrix} \qquad formula 5$$

where

Pᵣ(i|u, z_{M}) represents a probability that the user u selects the leaf node i under a content category corresponding to a branch node z_{M}, and Πₘ₌₁^{M} Pᵣ(zₘ|u, zₘ₋₁) represents probabilities that the user u respectively selects a root node z₀ and nodes z₁, z₂, . . . , z_{M}, where M is a quantity of all nodes of the content tree.

After a probability that the user u selects each leaf node is determined, a content corresponding to at least one leaf node may be recommended to the user u based on the probability, for example, a content corresponding to a leaf node whose probability is the highest may be recommended; or contents corresponding to several leaf nodes whose probabilities are highest may be recommended; or contents corresponding to leaf nodes whose probabilities are greater than a set probability threshold may be recommended, which is not specifically limited in this embodiment of this application.

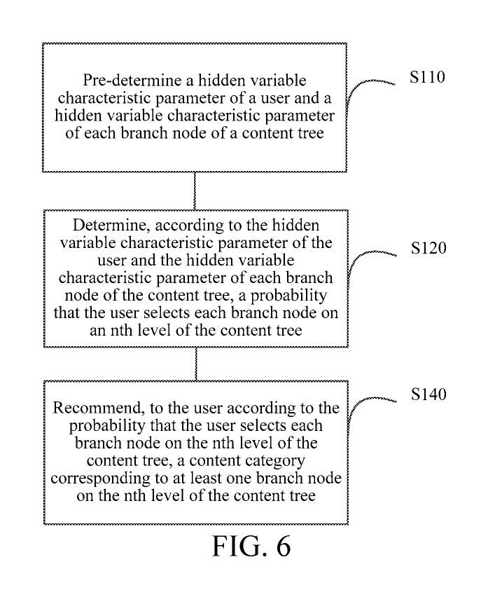

Optionally, as shown in FIG. 6, before S120, the method may further comprise:

S110: Pre-determine the hidden variable characteristic parameter of the user and the hidden variable characteristic parameter of each branch node of the content tree.

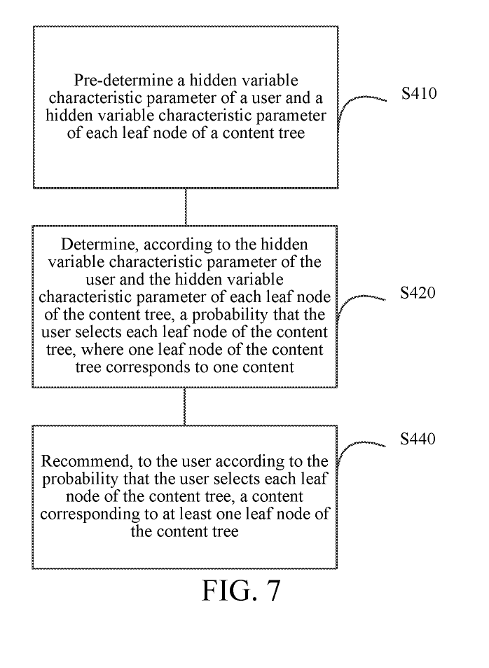

Optionally, as shown in FIG. 7, before S420, the method may further comprise:

S410: Pre-determine the hidden variable characteristic parameter of the user and the hidden variable characteristic parameter of each leaf node of the content tree.

Parameter determining manners in S110 and S410 are similar, and are therefore described together herein.

Generally, a hidden variable characteristic parameter [symbol] of a node z is affected by a hidden variable characteristic parameter [symbol] of a father node π_{z} of the node z; therefore, in this embodiment of this application, it may be assumed that the hidden variable characteristic parameter [symbol] of the node z is a normal distribution function based on the hidden variable characteristic parameter [symbol] of the father node π_{z} of the node z as a mean value. Therefore, it may be assumed that

$$\vec{{q}_{z}} = \{ \begin{matrix} ( 0 , {σ}^{2} \vec{I} ) & if the node z is a root node \\ ( \vec{{q}_{{π}_{z}}} , {σ}^{2} \vec{I} ) & if the node z is not a root node\end{matrix}$$

formula 6, where

a mean value of [symbol] (μ, σ² [symbol] is μ, and a standard deviation parameter of [symbol] (μ, σ²Ĩ) is a normal distribution of σ,

Based on the forgoing assumption, it may be assumed that Θ={ [symbol] , [symbol] , [symbol] , bᵢ, b_{z}}; therefore, in the content tree Γ, a probability distribution of the parameter Θ that satisfies [symbol] ={μ, i, pathᵢ)} may be represented by the following:

$${P}_{r} ( Θ \vert 𝒟 , Γ ) ∝ {\prod }_{u = 1}^{U} {\prod }_{i = 1}^{I} {P}_{r} ( i \vert u , {z}_{M} ) {\prod }_{m = 1}^{M} {P}_{r} ( {z}_{m} \vert u , {z}_{m - 1} ) \times {\prod }_{{{∀}_{z} ∈ Γ}^{m = 1}}^{M} {P}_{r} ( \vec{{q}_{{z}_{m}}} \vert \vec{{q}_{{z}_{m - 1}}} , {σ}^{2} \vec{I} ) {P}_{r} ( \vec{{q}_{{z}_{0}}} \vert 0 , {σ}^{2} \vec{I} ) \times {\prod }_{u} {P}_{r} ( \vec{{p}_{u}} \vert 0 , {σ}^{2} \vec{I} ) , \qquad formula 7$$

where

[symbol] ={(μ, i, pathᵢ)} indicates that the user u selects the leaf node i through a path pathᵢ; U represents a quantity of users; I represents a quantity of leaf nodes; ∀_{z} represents all nodes that belong to the content tree Γ; σ represents a standard deviation parameter of a normal distribution; [symbol] represents a unit matrix; and meanings of the other parameters are same as those in the foregoing embodiments, and are not described repeatedly herein.

Learning may be performed, for example, a historical choice record of the user is collected or a value is assigned, to cause Pᵣ (↓| [symbol] , Γ) to reach its maximum value, and Θ obtained in this case is a final learning result of the parameter. That is, the hidden variable characteristic parameter of the user and the hidden variable characteristic parameter of each branch node of the content tree in S110 may be determined; or the hidden variable characteristic parameter of the user and the hidden variable characteristic parameter of each leaf node of the content tree in S410 may be determined. Many parameter learning manner can be used, provided that Pᵣ (Θ| [symbol] , Γ) can reach its maximum value, which is not specifically limited in this embodiment of this application.

In any one of the foregoing embodiments of this application, if the content tree is an application tree, the content category may be an APP category; if the content tree is a commodity tree, the content category may be a commodity category; if the content tree is a search result tree, the content category may be a search result category.

Likewise, in any one of the foregoing embodiments of this application, if the content tree is an APP tree, the content may be an APP category; if the content tree is a commodity tree, the content may be a commodity; if the content tree is a search result tree, the content may be a search result.

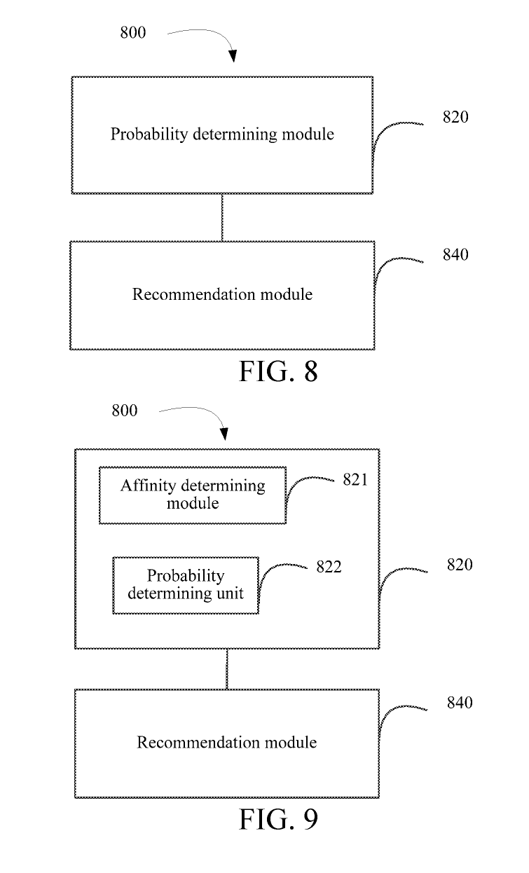

FIG. 8 is a schematic structural diagram of a recommendation apparatus 800 according to an embodiment of this application. Referring to FIG. 8, the apparatus comprises:

a probability determining module 820, configured to determine, according to a hidden variable characteristic parameter of a user and a hidden variable characteristic parameter of each branch node of a content tree, a probability that the user selects each branch node on an nth level of the content tree, where one branch node of the content tree corresponds to one content category, and n is a natural number greater than 1; and

a recommendation module 840, configured to recommend, to the user according to the probability that the user selects each branch node on the nth level of the content tree, a content category corresponding to at least one branch node on the nth level of the content tree.

According to the recommendation apparatus described in this embodiment of this application, a probability that a user selects each branch node on a specific level in a tree structure of to-be-recommended contents can be determined according to a hidden variable characteristic parameter of the user, and a recommendation of a content category is given based on the probability, which overcomes a problem in the prior art that a need of a user for customization is overlooked, so that a customized recommendation can be given to a user more accurately.

Optionally, as shown in FIG. 9, the probability determining module 820 may comprise:

an affinity determining unit 821, configured to calculate an affinity between the user and each branch node on the nth level of the content tree according to the hidden variable characteristic parameter of the user and a hidden variable characteristic parameter of each branch node on the nth level of the content tree; and

a probability determining unit 822, configured to determine, according to the affinity between the user and each branch node on the nth level of the content tree, the probability that the user selects each branch node on the nth level of the content tree.

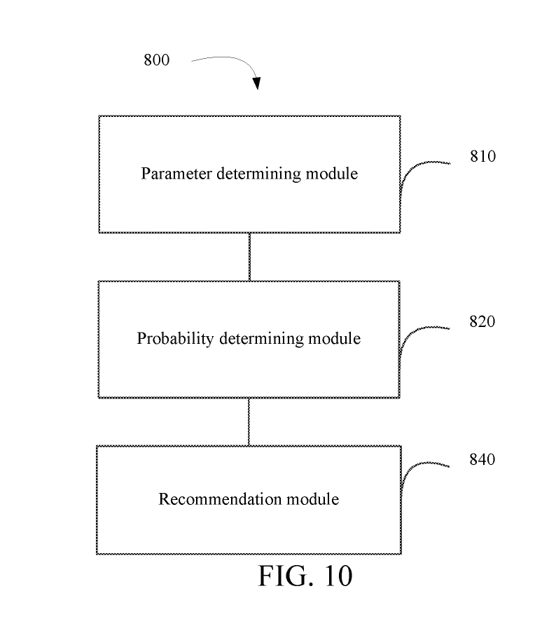

Optionally, as shown in FIG. 10, the recommendation apparatus 800 may further comprise:

a parameter determining module 810, configured to pre-determine the hidden variable characteristic parameter of the user and the hidden variable characteristic parameter of each branch node of the content tree.

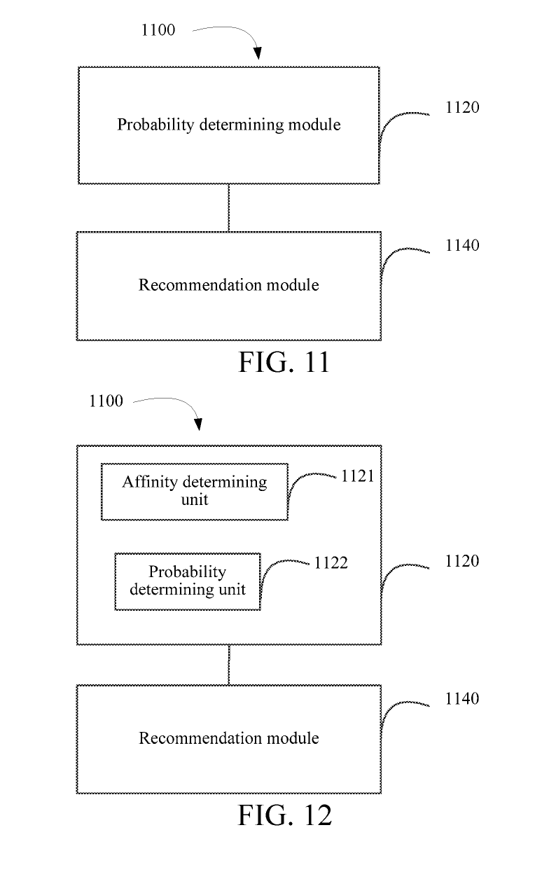

FIG. 11 is a schematic structural diagram of another recommendation apparatus 1100 according to another embodiment of this application. Referring to FIG. 11, the apparatus comprises:

a probability determining module 1120, configured to determine, according to a hidden variable characteristic parameter of a user and a hidden variable characteristic parameter of each leaf node of a content tree, a probability that the user selects each leaf node of the content tree, where one leaf node of the content tree corresponds to one content; and

a recommendation module 1140, configured to recommend, to the user according to the probability that the user selects each leaf node of the content tree, a content corresponding to at least one leaf node of the content tree.

According to the recommendation apparatus described in this embodiment of this application, a probability that a user selects each leaf node in a tree structure of to-be-recommended contents can be determined according to a hidden variable characteristic parameter of the user, and a recommendation of a content is given based on the probability, which overcomes a problem in the prior art that a need of a user for customization is overlooked, so that a customized recommendation can be given to a user more accurately.

Optionally, as shown in FIG. 12, the probability determining module 1120 may comprise:

an affinity determining unit 1121, configured to calculate an affinity between the user and each leaf node of the content tree according to the hidden variable characteristic parameter of the user and the hidden variable characteristic parameter of each leaf node of the content tree; and

a probability determining unit 1122, configured to determine, according to the affinity between the user and each leaf node of the content tree, the probability that the user selects each leaf node of the content tree.

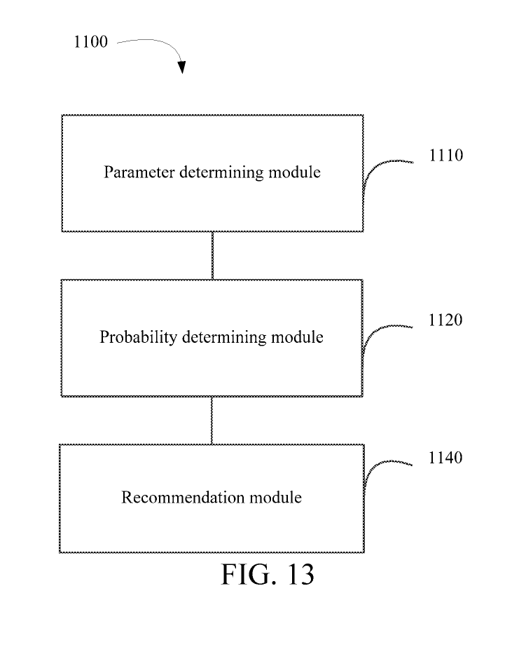

Optionally, as shown in FIG. 13, the recommendation apparatus 1100 may further comprise:

a parameter determining module 1110, configured to pre-determine the hidden variable characteristic parameter of the user and the hidden variable characteristic parameter of each leaf node of the content tree.

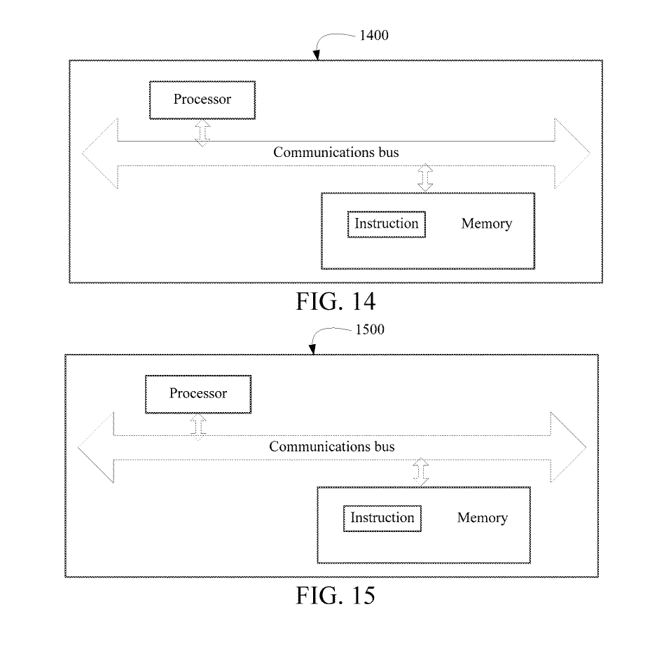

As shown in FIG. 14, another embodiment of this application further provides a recommendation apparatus 1400, comprising: a memory and a processor, where the memory is configured to store an instruction; and the processor is configured to execute the instruction, to perform the following steps:

determining, according to a hidden variable characteristic parameter of a user and a hidden variable characteristic parameter of each branch node of a content tree, a probability that the user selects each branch node on an nth level of the content tree, where one branch node of the content tree corresponds to one content category, and n is a natural number greater than 1; and

recommending, to the user according to the probability that the user selects each branch node on the nth level of the content tree, a content category corresponding to at least one branch node on the nth level of the content tree.

The processor may be a central processing unit (CPU), or an application-specific integrated circuit (ASIC), or one or more integrated circuits configured to implement an embodiment of the recommendation method.

The memory may be any medium that can store program code, such as a USB flash drive, a removable hard disk, a read-only memory (ROM), a random access memory (RAM), a magnetic disk, or an optical disc.

The processor and the memory may communicate with each other by using a communications bus.

As shown in FIG. 15, another embodiment of this application further provides a recommendation apparatus 1500, comprising: a memory and a processor, where the memory is configured to store an instruction; and the processor is configured to execute the instruction, to perform the following steps:

determining, according to a hidden variable characteristic parameter of a user and a hidden variable characteristic parameter of each leaf node of a content tree, a probability that the user selects each leaf node of the content tree, where one leaf node of the content tree corresponds to one content; and

recommending, to the user according to the probability that the user selects each leaf node of the content tree, a content corresponding to at least one leaf node of the content tree.

The processor may be a CPU, or an ASIC, or one or more integrated circuits configured to implement an embodiment of the recommendation method.

The memory may be any medium that can store program code, such as a USB flash drive, a removable hard disk, an ROM, an RAM, a magnetic disk, or an optical disc.

A person skilled in the art can clearly understand that for convenience and brevity, the above described recommendation method may be implemented by the above described recommendation apparatus in this application, and reference may be made to a description of a corresponding process in the foregoing embodiment of the recommendation method in this application, and details are not described repeatedly herein.

For a better understanding of the embodiments of this application, some terms involved in this application are described herein:

1. Node: represents a data element in a tree, and is formed by a relationship between a data item and a data element. In FIG. 2, there are 17 nodes in total.

2. Degree of Node: a quantity of child trees of a node. In FIG. 2, a degree of a root node is 5.

3. Leaf Node: a node whose degree is 0, also called a terminal node. In FIG. 2, all nodes filled with oblique lines are leaf nodes.

4. Branch Node: a node whose degree is not 0, also called a non-terminal node or an inside node. In FIG. 2, all blank nodes are branch nodes.

5. Brother nodes: child nodes having a same father node.

6. Level of Node: a quantity of branches on a path from a root node to a specific node in a tree is referred to as a level of the node. It is specified that a level of a root node is 1, and levels of other nodes are equal to levels of parent nodes of these nodes plus 1.

A person of ordinary skill in the art may realize that the exemplary units and method steps described with reference to the embodiments disclosed in this application can be implemented by electronic hardware or a combination of computer software and electronic hardware. Whether these functions are implemented in a manner of hardware or software depends on a specific application and a designed constraint condition of the technical solutions. A person skilled in the art can use different methods for each specific application to implement the described functions, but such implementation shall not be construed as exceeding the scope of this application.

If the functions are implemented in forms of software functional units and sold or used as an independent product, the functions may be stored in a computer-readable storage medium. Based on such an understanding, the technical solutions of this application essentially, or the part contributing to the prior art, or a part of the technical solutions may be implemented in a form of a software product. The software product is stored in a storage medium, and comprises several instructions for instructing a computer device (which may be a personal computer, a controller, or a network device) to perform all or a part of the steps of the methods described in the embodiments of this application. The forgoing storage medium comprises any medium that can store program code, such as a USB flash drive, a mobile hard disk, an ROM, an RAM, a magnetic disk, or an optical disc.

The foregoing implementation manners are merely used to describe this application, and are not used to limit this application. A person of ordinary skill in the art can make various modifications and variations without departing from the spirit and scope of this application. Therefore, all equivalent technical solutions also fall into the scope of this application, and the patent protection scope of this application shall be limited to the claims.

What is claimed is:

1. A recommendation method, comprising:
determining, according to a hidden variable characteristic parameter of a user and a hidden variable characteristic parameter of each branch node of a content tree, a probability that the user selects each branch node on an n^{th} level of the content tree, wherein one branch node of the content tree corresponds to one content category, and n is a natural number greater than 1; and
recommending, to the user according to the probability that the user selects each branch node on the n^{th} level of the content tree, a content category corresponding to at least one branch node on the n^{th} level of the content tree.

2. The method of claim 1, wherein the determining, according to a hidden variable characteristic parameter of a user and a hidden variable characteristic parameter of each branch node of a content tree, a probability that the user selects each branch node on an n^{th} level of the content tree comprises:
calculating an affinity between the user and each branch node on the n^{th} level of the content tree according to the hidden variable characteristic parameter of the user and a hidden variable characteristic parameter of each branch node on the n^{th} level of the content tree; and
determining, according to the affinity between the user and each branch node on the n^{th} level of the content tree, the probability that the user selects each branch node on the n^{th} level of the content tree.

3. The method of claim 2, wherein the affinity between the user and each branch node on the n^{th} level of the content tree is a dot product of the hidden variable characteristic parameter of the user and the hidden variable characteristic parameter of each branch node on the n^{th} level of the content tree.

4. The method of claim 1, wherein the method further comprises:
pre-determining the hidden variable characteristic parameter of the user and the hidden variable characteristic parameter of each branch node of the content tree.

5. The method of claim 1, wherein the content tree is an application tree, and the content category is an APP category; or
the content tree is a commodity tree, and the content category is a commodity category; or
the content tree is a search result tree, and the content category is a search result category.

6. A recommendation method, comprising:
determining, according to a hidden variable characteristic parameter of a user and a hidden variable characteristic parameter of each leaf node of a content tree, a probability that the user selects each leaf node of the content tree, wherein one leaf node of the content tree corresponds to one content; and
recommending, to the user according to the probability that the user selects each leaf node of the content tree, a content corresponding to at least one leaf node of the content tree.

7. The method of claim 6, wherein the determining, according to a hidden variable characteristic parameter of a user and a hidden variable characteristic parameter of each leaf node of a content tree, a probability that the user selects each leaf node of the content tree comprises:
calculating an affinity between the user and each leaf node of the content tree according to the hidden variable characteristic parameter of the user and the hidden variable characteristic parameter of each leaf node of the content tree; and
determining, according to the affinity between the user and each leaf node of the content tree, the probability that the user selects each leaf node of the content tree.

8. The method of claim 7, wherein the affinity between the user and each leaf node of the content tree is a dot product of the hidden variable characteristic parameter of the user and the hidden variable characteristic parameter of each leaf node of the content tree.

9. The method of claim 6, wherein the method further comprises:
pre-determining the hidden variable characteristic parameter of the user and the hidden variable characteristic parameter of each leaf node of the content tree.

10. The method of claim 6, wherein the content tree is an APP tree, and the content is an APP; or
the content tree is a commodity tree, and the content is a commodity; or
the content tree is a search result tree, and the content is a search result.

11. A recommendation apparatus, comprising:
a probability determining module, configured to determine, according to a hidden variable characteristic parameter of a user and a hidden variable characteristic parameter of each branch node of a content tree, a probability that the user selects each branch node on an n^{th} level of the content tree, wherein one branch node of the content tree corresponds to one content category, and n is a natural number greater than 1; and
a recommendation module, configured to recommend, to the user according to the probability that the user selects each branch node on the n^{th} level of the content tree, a content category corresponding to at least one branch node on the n^{th} level of the content tree.

12. The apparatus of claim 11, wherein the probability determining module comprises:
an affinity determining unit, configured to calculate an affinity between the user and each branch node on the n^{th} level of the content tree according to the hidden variable characteristic parameter of the user and a hidden variable characteristic parameter of each branch node on the n^{th} level of the content tree; and
a probability determining unit, configured to determine, according to the affinity between the user and each branch node on the n^{th} level of the content tree, the probability that the user selects each branch node on the n^{th} level of the content tree.

13. The apparatus of claim 11, wherein the apparatus further comprises:
a parameter determining module, configured to pre-determine the hidden variable characteristic parameter of the user and the hidden variable characteristic parameter of each branch node of the content tree.

14. A recommendation apparatus, comprising:
a probability determining module, configured to determine, according to a hidden variable characteristic parameter of a user and a hidden variable characteristic parameter of each leaf node of a content tree, a probability that the user selects each leaf node of the content tree, wherein one leaf node of the content tree corresponds to one content; and
a recommendation module, configured to recommend, to the user according to the probability that the user selects each leaf node of the content tree, a content corresponding to at least one leaf node of the content tree.

15. The apparatus of claim 14, wherein the probability determining module comprises:
an affinity determining unit, configured to calculate an affinity between the user and each leaf node of the content tree according to the hidden variable characteristic parameter of the user and the hidden variable characteristic parameter of each leaf node of the content tree; and
a probability determining unit, configured to determine, according to the affinity between the user and each leaf node of the content tree, the probability that the user selects each leaf node of the content tree.

16. The apparatus of claim 14, wherein the apparatus further comprises:
a parameter determining module, configured to pre-determine the hidden variable characteristic parameter of the user and the hidden variable characteristic parameter of each leaf node of the content tree.

17. A recommendation apparatus, comprising: a memory and a processor, wherein the memory is configured to store an instruction; and the processor is configured to execute the instruction, to perform the following steps:
determining, according to a hidden variable characteristic parameter of a user and a hidden variable characteristic parameter of each branch node of a content tree, a probability that the user selects each branch node on an n^{th} level of the content tree, wherein one branch node of the content tree corresponds to one content category, and n is a natural number greater than 1; and
recommending, to the user according to the probability that the user selects each branch node on the n^{th} level of the content tree, a content category corresponding to at least one branch node on the n^{th} level of the content tree.

18. A recommendation apparatus, comprising: a memory and a processor, wherein the memory is configured to store an instruction; and the processor is configured to execute the instruction, to perform the following steps:
determining, according to a hidden variable characteristic parameter of a user and a hidden variable characteristic parameter of each leaf node of a content tree, a probability that the user selects each leaf node of the content tree, wherein one leaf node of the content tree corresponds to one content; and
recommending, to the user according to the probability that the user selects each leaf node of the content tree, a content corresponding to at least one leaf node of the content tree.
